(19) United States
(12) Patent Application Publication
(10) Pub. No.: US 2015/0316404 A1
(43) Pub. Date: Nov. 5, 2015

(54) MEASUREMENT OF FLUID VOLUME OF A BLOOD OXYGENATOR IN AN EXTRACORPOREAL CIRCUIT

(71) Applicant: Transonic Systems, Inc., Ithaca, NY (US)

(72) Inventors: Nikolai M. Krivitski, Ithaca, NY (US); Naveen Thuramalla, Ithaca, NY (US); Gregory Galyanov, Ithaca, NY (US)

(73) Assignee: Transonic Systems, Inc., Ithaca, NY (US)

(21) Appl. No.: 14/268,679

(22) Filed: May 2, 2014

(51) Int. Cl. G01F 22/00; G01F 1/66; G01F 22/02

(52) U.S. Cl. CPC G01F 22/00; G01F 22/02; G01F 1/662

(57) ABSTRACT

The present disclosure provides a method and apparatus for measuring or monitoring oxygenator blood volume of a treatment device such as an oxygenator by analyzing an indicator passing through the oxygenator blood volume. Measuring the oxygenator blood volume can be done externally of the vein or artery, or in tubing leading to a blood treatment system which carries the blood exterior of the body of the patient or within the body of the patient. The present system can also monitor tubing volume of flowing blood upstream or downstream of the blood treatment device. The present system thus provides for measuring the volume of an extracorporeal circuit and creates an opportunity to control circuit performance and give an early warning of clotting to improve the quality of a variety of extracorporeal procedures with the use of relatively simple technology.

### FIELD OF THE INVENTION

The present invention relates to monitoring extracorporeal systems, and more particularly to the measurement and monitoring of fluid volume in a blood treatment device, such as an oxygenator in an extracorporeal system, wherein the measurement and monitoring of the fluid volume can be in real time.

### BACKGROUND OF THE INVENTION

In a large number of medical procedures, at least a portion of the patient blood volume is passed through an extracorporeal system for treatment. This system can be, but not limited to, extracorporeal membrane oxygenation (ECMO), or cardio-pulmonary bypass circuit or an artificial lung system. These systems are broadly used in life support and blood cleaning treatment, including but not limited to oxygenator, artificial lung and blood component exchanges.

The conduit where blood is exposed to treatment usually includes a number of fibers or other large surface area structures that expose the blood to the large surface areas for effective treatment. However, this exposure of blood to the large surface areas is prone to blood clotting.

Due to the exposure of the blood to the large surface area, clotting may occur in the circuit and thereby significantly decrease the surface area available to the blood for exchange. The reduced surface area reduces the efficacy of treatment or can occlude the circuit altogether. Severe clotting can cause a circuit blockage and stop circuit flow entirely. In this case the quality of treatment or the life of the patient may be jeopardized.

A further complication occurs as clots that can form in the extracorporeal circuit may be delivered into patient and can lead to life threatening complications.

As an overall amount of clotting is often difficult to determine, circuit replacements are frequently done even if non harmful clots are detected. This process is not only time consuming and wasteful of resources, but the process exposes the patient to additional infection risk and new foreign materials.

Also, the interruption of the treatment process can be detrimental to the treatment of the patient. For example, in procedures such as extracorporeal membrane oxygenation, during a circuit replacement, the patient would not be receiving oxygenation support.

Therefore, the need exists for a method and apparatus for monitoring a volume of a blood treatment device, such as an oxygenator, wherein changes in volume can be monitored and measured to help assess clotting in the blood treatment device. A need also exists for the real time monitoring of treatment device volume as a decrease in volume can indicate clotting. The need also exists for monitoring a change in the volume of the treatment device to allow adjustments to the procedures and treatment to minimize patient harm.

### SUMMARY OF THE INVENTION

Generally, the present disclosure relates to a method and apparatus for measuring or monitoring blood volume in a blood treatment or blood volume delivery device. For purposes of description, the blood treatment device is referred to as a blood oxygenator, such as an extracorporeal membrane oxygenator (ECMO), wherein the blood volume is referred to as oxygenator blood volume (OXBV). It is understood the system and method are not limited to the ECMO configuration.

In a first embodiment, a method of monitoring a blood volume of an oxygenator in an extracorporeal circuit is provided by determining a flow rate in the extracorporeal circuit; introducing a volume change in the extracorporeal circuit, such as by injecting an indicator into the extracorporeal circuit; sensing a time occurrence of the introduction corresponding to the volume change in the system (extracorporeal circuit or portion) such as by a flow rate change or by a pressure change in the extracorporeal circuit resulting from the introduced volume change in the extracorporeal circuit; determining a time parameter at least partly derived from a dilution curve corresponding to the injected indicator; and determining the blood volume of the oxygenator based on the determined time parameter and the determined flow rate in the extracorporeal circuit.

Fundamentally, in all cases where a flow rate change is used to identify volume change such as an injection or introduction of an indicator, a pressure sensor can alternatively or in combination be used to sense the volume change (the indicator introduction) to the extracorporeal circuit or portion of the extracorporeal circuit. It is understand that in order to calculate a volume in the extracorporeal circuit, such as a fluid volume including an oxygenator blood volume, a measurement or calculation of flow rate needs to be made. Thus, in a configuration using pressure to identify the indicator injection moment (time), the system would employ three sensors: a pressure sensor, a flow rate sensor and a dilution sensor.

It is contemplated the time parameter is determined from passage of a predetermined portion of the dilution curve and the sensed introduced volume change—either by a flow rate change or a pressure change in the circuit. In addition, the determined blood volume can be adjusted by a volume of the extracorporeal circuit upstream of the oxygenator as well as a volume of the extracorporeal circuit downstream of the oxygenator.

In a second embodiment, a method is provided for monitoring a blood volume of an oxygenator in an extracorporeal circuit, by introducing, at an introduction location, a temperature change to passing blood in the extracorporeal circuit; sensing, with a sensor located in the extracorporeal circuit downstream of the oxygenator, passage of the introduced temperature change; determining a time parameter derived from travel of the introduced temperature change from the introducing location to the sensor; and determining the blood volume of the oxygenator based on a blood flow rate in the extracorporeal circuit and the time parameter.

In this configuration the temperature change can be introduced to passing blood in the extracorporeal circuit by one of (i) introducing the temperature change through a heating/cooling system thermally coupled to the extracorporeal circuit at an introducing location in the extracorporeal circuit and (ii) introducing a volume of indicator into the extracorporeal circuit, the volume of indicator having a different temperature than the passing blood. Thus, introducing a temperature change to passing blood in the extracorporeal circuit includes introducing a volume of indicator into a temperature control circuit thermally coupled to (and fluidly separated from) the extracorporeal circuit, upstream of the oxygenator.

In a third configuration, a method of monitoring a blood volume of an oxygenator in an extracorporeal circuit is provided, by introducing a change in a gas property of blood flowing in the extracorporeal circuit; sensing, with a sensor located in the extracorporeal circuit downstream of the oxygenator, passage of the changed gas property in the blood; and calculating the blood volume of the oxygenator based on a blood flow rate in the extracorporeal circuit and a time parameter derived from travel of the changed gas property from the introduction to the sensor.

In this configuration, the introduced change in the gas property can be provided by a gas delivery system coupled to the extracorporeal circuit.

Alternatively, a method is provided for dynamically monitoring an oxygenator blood volume in an extracorporeal circuit, by determining at a first time, a first relative oxygenator blood volume corresponding to a first flow rate in the extracorporeal circuit and a first time parameter derived from a sensed passage by an outflow sensor of a first indicator through the oxygenator; determining at a second time, a second relative oxygenator blood volume corresponding to a second flow rate in the extracorporeal circuit and a second time parameter derived from a sensed passage by the outflow sensor of a second indicator through oxygenator; and comparing the first relative oxygenator blood volume and the second relative oxygenator blood volume to assess a change in oxygenator blood volume.

Thus, the present method and apparatus can measure and/or monitor OXBV by analyzing indicator, such as a dilution indicator, passing through the OXBV.

The present method and apparatus provides for measuring OXBV, as well as, determining OXBV and particularly externally of the vein or artery, or in tubing leading to the blood treatment device, wherein the tubing carries the blood exterior of the body of the patient or within the body of the patient. Thus, the present system can be used for devices implanted in the patient.

Further, as clots can also occur in tubing lines, the present system can be used to monitor tubing volume of flowing blood, blood volume in the pump or any other part of any extracorporeal circuit or circuit implanted in the patient.

The present system thus provides for measuring the volume of an extracorporeal circuit and creates an opportunity to control circuit performance and give an early warning of clotting to improve the quality of a variety of extracorporeal procedures with the use of relatively simple technology.

The following will describe embodiments of the present disclosure, but it should be appreciated that the present disclosure is not limited to the described embodiments and various modifications of the invention are possible without departing from the basic principle. The scope of the present disclosure is therefore to be determined solely by the appended claims.

### BRIEF DESCRIPTION OF THE DRAWINGS

FIG. 1 is an extracorporeal membrane oxygenator (ECMO) system with sensors and apparatus for measures of OXBV and changes in the OXBV.

FIG. 2 is a set of dilution curves recoded upstream and downstream of the treatment device, such as an oxygenator (example for thermodilution).

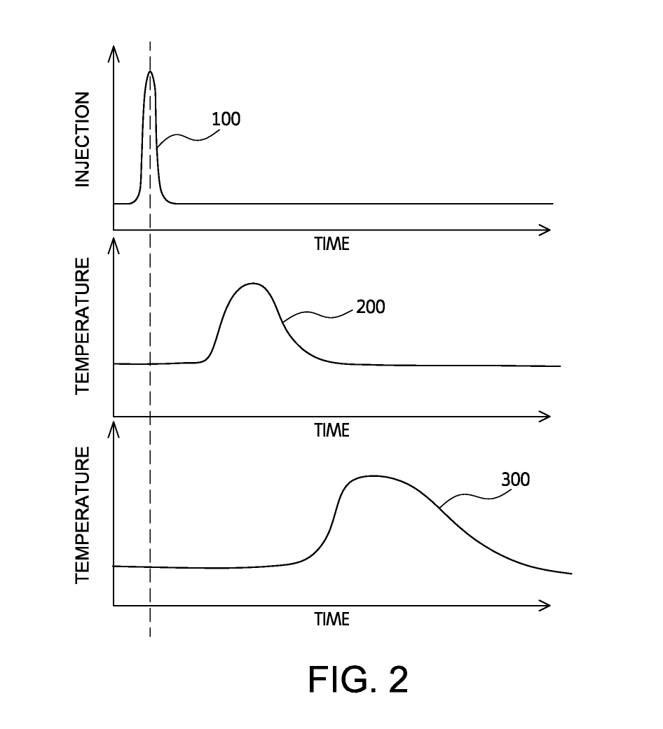

FIG. 3 is a schematic representation of an ECMO system with a single outflow dilution sensor for use in measuring OXBV and changes in OXBV.

FIG. 4 is a set of ultrasound dilution curves and flow changes for single sensor system of FIG. 3.

FIG. 4A is a set of curves including a sensed pressure change for the system employing a sensed pressure in the calculation of the fluid volume under study.

FIG. 5 is a schematic representation of an ECMO system with heat-cold bolus introduced from HCS side with single outflow sensor, such as a thermodilution sensor.

FIG. 6 is a set of thermodilution curves and injection for the single outflow sensor system.

FIG. 7 is a schematic representation of an ECMO system with heat-cold bolus introduced from HCS side upstream of the treatment device, oxygenator, with an upstream and a downstream sensor, such as dilution sensors and particularly thermodilution sensors.

FIG. 8 is a set of thermodilution curves for two thermal sensor system of FIG. 7.

FIG. 9 is a schematic representation of an ECMO system with gas property changes introduced through a GDS or temperature introduced through an HCS.

FIG. 10 is a set of dilution curves and injection timing for the indicator introduced through the GDS or the HCS of FIG. 9.

FIG. 11 is a schematic representation of the calculations and volumes in one configuration.

### DETAILED DESCRIPTION OF THE INVENTION

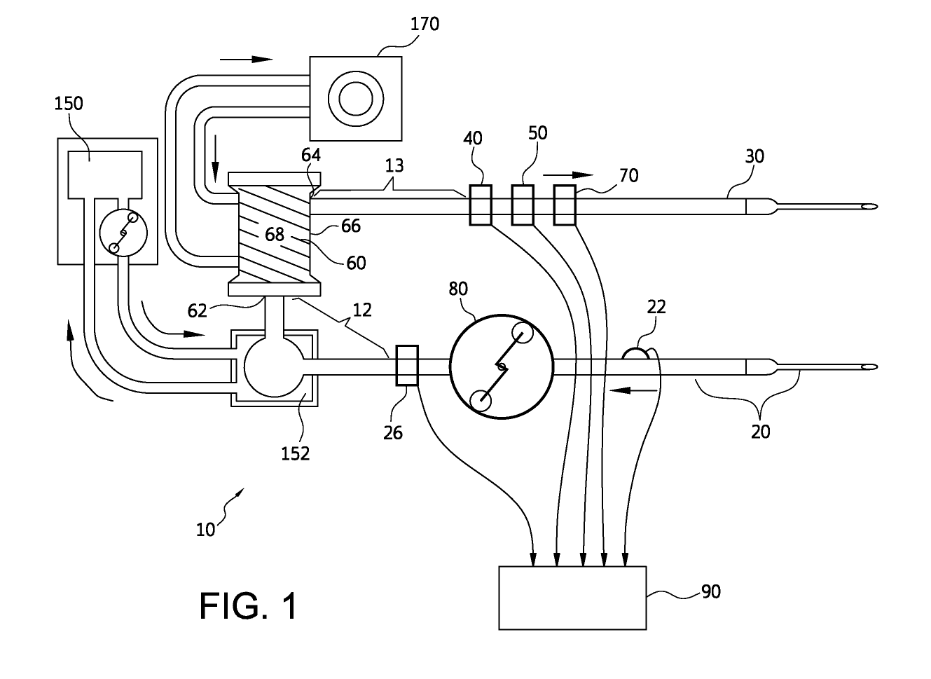

Referring to FIG. 1, an extracorporeal circuit 10 includes a venous line 20, an arterial line 30, an outflow sensor 40 and a treatment device 60. In select configurations, the extracorporeal circuit 10 further includes a flow rate sensor 70, a pump 80 and a controller 90.

The venous, or withdrawal line 20 passes blood from a native vessel of the patient to the treatment device 60. The arterial, or delivery line 30 passes blood from treatment device 60 to a native vessel of the patient.

The treatment device 60 can be any treatment device for controllably altering a property or parameter of the blood including, but not limited to devices pumping blood for treatment, or any part of such devices. For purposes of description, the treatment device 60 is set forth as an oxygenator, such as a blood oxygenator 66 and particularly an extracorporeal membrane oxygenator (ECMO). However, it is understood the treatment device 60 could be any of a variety of devices that alter a property or parameter of the blood. The treatment device 60 has an inlet 62 fluidly connecting to the venous line 20 and an outlet 64 fluidly connected to the arterial line 30.

The blood oxygenator 66 defines a fluid volume 68, OXBV, for imparting blood treatment. In one configuration, the OXBV 68 is the operational volume of the treatment device 60, wherein changes to the OXBV can be used by medical personnel to assess the efficacy of treatment and status of the system. The blood volume in the extracorporeal circuit 10 exposed to the non blood native blood vessels in a part of the extracorporeal circuit under investigation on clotting can be described in extracorporeal membrane oxygenation as the oxygenator blood volume (OXBV) 68, wherein a decrease of OXBV will be a sign of clotting process in the blood volume.

The pump 80 is used to control or regulate the passage of blood through the extracorporeal circuit 10. The pump can be any of a variety of medical pumps known in the art, including roller pumps and centrifugal pumps. In certain configurations, the pump is connected to the controller and can be operated under direction of the controller. Thus, the pump 80 can provide a relatively constant flow rate through the extracorporeal circuit 10 (and blood treatment device 60) or a variable rate through the circuit.

One of the venous line 20 and the treatment device 60 includes an indicator introduction port 22 for selectively introducing the indicator into the extracorporeal circuit 10. As set forth below, the indicator can be either a volume change or an induced (such as a coupled) change. The induced change can be referred to as a coupled change in that the blood in the extracorporeal circuit 10 is coupled to (though not fluidly connected to) an external device. That is, a characteristic or parameter of the blood in the extracorporeal circuit 10 changes or alters corresponding to a change in an external device. The indicator introduction port 22 can be an interface to the external device or have a corresponding structure for the indicator, as known in the art.

The indicator is any substance that alters a measurable blood property. The indicator can alter any measurable parameter of the blood. For example, the indicator may be chemical, optical, electrical, thermal or any combination thereof. Thus, the injected indicator can be any solution, including blood or plasma, that changes any physical or chemical blood property including but not limited to temperature, ultrasound velocity, density, optical density, saline concentration or other detectable change. The particular indicator is at least partly dictated by the anticipated operating environment. Available indicators include saline solutions, increased or decreased temperature as well as dyes and various isotopes. The use of temperature differentials can be accomplished by locally creating a heat source or a heat sink in the surrounding flow. The creation of a local temperature gradient offers the benefit of being able to employ a dilution indicator without introducing any additional volume into the blood flow in the extracorporeal circuit 10, such as a coupled change. That is, a temperature differential may be created without an accompanying introduction of a volume of indicator. Alternatively, a volume of heated or cooled blood or isotonic saline can be introduced at the indicator introduction port as the indicator.

The outflow sensor 40 is located in the arterial line 30 downstream of the OXBV 68 and senses passage of the indicator. In one configuration, the outflow sensor 40 is connected to the controller 90. The outflow sensor 40 is any sensor for sensing a changed property of the blood such as the corresponding indicator. The sensor can be, but is not limited to a dilution sensor including electrical impedance sensors, or optical sensors, wherein the particular sensor is dependent on the blood characteristics of interest. Ultrasound velocity dilution sensors, as well as temperature sensors and optical density, density or electrical impedance sensors can be used to detect changes in blood parameters. The operating parameters of the particular system will substantially dictate the specific design characteristics of the dilution sensor, such as the particular sound velocity sensor. Ultrasonic sensors measure sound velocity as the indicator material is carried past the sensor by the blood flow, and changes in sound velocity are plotted to permit calculation of various blood parameters. The time at which the indicator reaches the outflow sensor 40 after injection, the area under the plotted curve representing the changes in sound velocity at the sensor, the shape of such curve and the amplitude of the measurement all provide information concerning the blood flow in the extracorporeal circuit 10.

The chosen type of sensor as the outflow sensor 40 can include a dilution sensor capable of measuring a concentration or effect of the introduced changes in the blood. The changes can include a temperature of the gas, if the gas was heated or cooled. Alternatively, the outflow sensor 40 can be a sensor for measuring gas concentration respective to what gas was employed as the indicator.

The outflow sensor 40 that records the thermodilution curve can be located within the treatment device 60, such as the oxygenator 66, in the arterial line 30, clamped or inserted into the arterial line or on the outside of the arterial line. The connection to the controller 90 can be wired or wireless, depending on the intended operating parameters.

The flow rate sensor 70 can be any sensor that measures blood flow in the system, at least in the extracorporeal circuit 10, and can record flow changes related or corresponding to introduction of the indicator. The flow rate sensor 70 can be an ultrasound flow sensor or dilution flow sensor as known in the art, including but not limited to flow meters, ultrasound flow meters including transit time or Doppler, or electromagnetic or other principles known in the art, as well as dilution principle. In one configuration, the flow rate sensor 70 is operably connected to the controller 90. Blood flow or blood flow rate is a measure of volume per unit time, such as 100 milliliters/minute.

As referenced below, in selected configurations, the venous line 20 or entrance to the treatment device 60 can include an inflow sensor 26 for sensing passage of the indicator. In such configurations, the inflow sensor 26 is operably connected to the controller 90.

For purposes of description, the term “upstream” of a given position refers to a direction against the flow of blood and the term “downstream” of a given position is the direction the blood flows away from the given position.

The controller 90 can be a programmed or programmable processor as known in the art. The controller 90 can be dedicated to the present system or method. Alternatively, the controller 90 can be a third party system running a program implementing the present system.

Generally, the indicator is introduced in the blood side (into the extracorporeal circuit 10) upstream of or into the OXBV 68 during operation of the extracorporeal circuit. That is, the indicator is introduced during flow through the OXBV 68. A signal corresponding to passage of indicator downstream of the OXBV 68 is obtained at the outflow sensor 40. The flow rate (sometimes referred to as a blood flow rate) through the circuit, or through the OXBV 68 is also determined, such as by the flow rate sensor 70. The OXBV 68 is then calculated in response to the signal and the determined blood flow rate.

Theory—The present system operates from the following principals. When flow rate (Q) in the extracorporeal circuit 10 can be measured, the OXBV 68 of the system is determined by the following equation [1]:

OXBV=Q×MTT [Equation. 1]

where Q is blood flow rate through the OXBV 68 and MTT is the mean transit time that the indicator travels through the OXBV, where MTT corresponds to:

$$MTT = \frac{\int C ( t ) * t * d t}{\int C ( t ) * d t}$$

where C(t) is the concentration of the dilution curve.

In practice, Equation 1 can be also expressed as:

OXBV=Q×(MTT_{after}−MTT_{before}) [Equation. 2]

where MTT_{before} is the mean transit time the indicator travels from the location of injection (introduction), such as indicator introduction port 22 to the inlet 62 of the oxygenator 66; MTT_{after} is the mean transit time the indicator travels from the location of injection (introduction), such as indicator introduction port 22 to the outlet 64 of oxygenator.

In case of very fast injection (indicator volume introduction) close to the inlet 62 of the OXBV 68, the value of MTT_{before} may be very small compared to MTT_{after} (close to zero).

The blood flow rate Q as in these equations and set forth below, can be measured by the flow rate sensor 70.

It is also understood that other formulas that use equivalents of MTT can be also used. This includes but is not limited to the time between a maximum of an incoming and outgoing dilution curve; a difference between appearance times of the dilution curves; values proportional to timing characteristics of the dilution curves. While these variations may simplify obtaining and assessment of the dilution curves, it is understood the variations may decrease accuracy of the measurement of the OXBV 68 versus the theoretical formulas (Equation 1 and Equation 2).

Equation 2 is correct in the configuration where the dilution curve and thus MTT_{after} is recorded by the outflow sensor 40 (such as a dilution sensor) immediately downstream of the OXBV. In the case of the outflow sensor 40 not immediately located downstream of the outlet 64 of the OXBV 68, the volume of the tubing (the flow path) between the outlet of the OXBV and the outflow sensor 40 (V_{after} in FIG. 1) needs to be subtracted for improved accuracy. Equation 3 sets forth this relation of improved accuracy.

OXBV=Q×(MTT_{outflow}−MTT_{inflow})−V_{after} [Equation 3]

where MTT_{outflow} is the mean transit time that the indicator travels from the location of injection (introduction), such as the indicator introduction port 22 to the outflow sensor 40 and V_{after} is the blood volume between the outlet 62 of the OXBV 66 and the outflow sensor.

Equation 3 is correct in the configuration of the system, where the dilution curve recorded by an inflow dilution sensor upstream of the OXBV is immediately at the inlet 62 of the OXBV 68. That is, there is minimal or no transit time of the indicator upstream of the OXBV 68.

In the case that MTT_{before} was not recorded immediately upstream of the inlet 62 of the OXBV 68, the volume of the flow path between the inlet to the OXBV and the location of the inflow sensor 26 (V_{before}, seen in FIG. 1), needs to be subtracted for better accuracy. Equation 4 sets forth this relation of improved accuracy.

OXBV=Q×(MTT_{outflow}−MTT_{inflow})−V_{before}−V_{after} [Equation 4]

where MTT_{inflow} is the mean transit time that the indicator travels from the location of injection (introduction), such as the indicator introduction port 22, to the inflow sensor 26 and V_{before} is the flow path volume (hence blood volume) upstream of the OXBV 68 between the inlet 62 of the OXBV and the inflow sensor 26, as seen in FIG. 1.

In a first embodiment of the system, an introduced volume change in the system (such as the introduction of the indicator) resulting in a corresponding change in—(i) the flow rate in the extracorporeal circuit 10 (and hence blood treatment device 60) or (ii) the pressure in the circuit is used to identify the characteristics of an injected volume of indicator, such as an injected bolus. For example, the change in flow rate or change in pressure can be used as the occurrence time of the indicator introduction. Thus, the time for the indicator to travel from the point of introduction to the downstream dilution sensor can be readily determined (as the time interval between the sensed flow rate or pressure change) and the passage of a portion of the dilution curve.

The time occurrence of the indicator introduction that partly defines MTT can be identified or determined in any of a variety of ways. For example, sensing, identifying or determining the occurrence time (the time the indicator is introduced) can be accomplished by an electronic signal that turns a volume injector on and off, a microphone sensing verbal commands, an optical or positional switch operably connected to an injection syringe of the indicator, even an operator monitored change to a flow characteristic, such as temperature or salinity of the fluid entering the oxygenator.

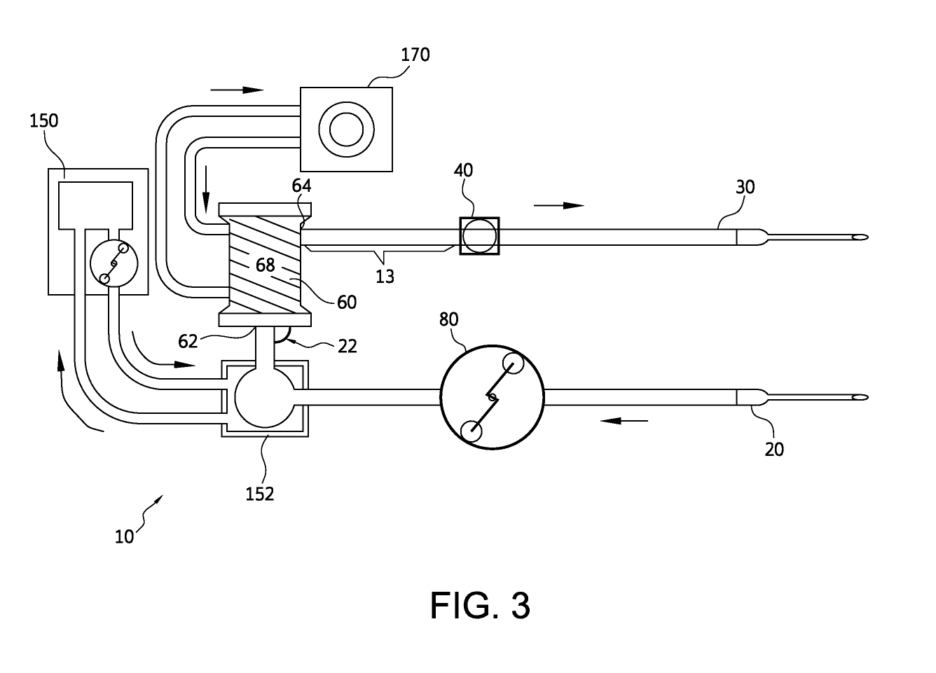

This embodiment includes the outflow sensor 40, such as the dilution sensor shown in FIG. 3. In the indicator dilution configuration, the outflow sensor 40 measures a change in ultrasound velocity due to passage of the injected of isotonic saline as the indicator. It is contemplated the outflow sensor 40 also can measure the blood flow rate using the transit time principle. Thus, in one configuration, the change in the flow rate and the passage of the indicator can be sensed or measured by a single sensor. However, it is understood a first sensor can be used for sensing the change in flow rate and a second sensor can be used to sense the passage of the indicator.

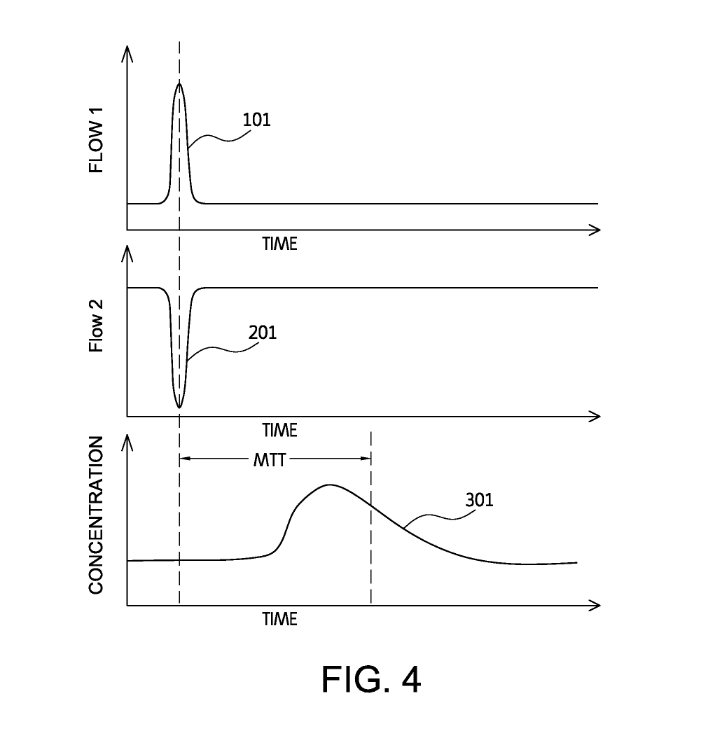

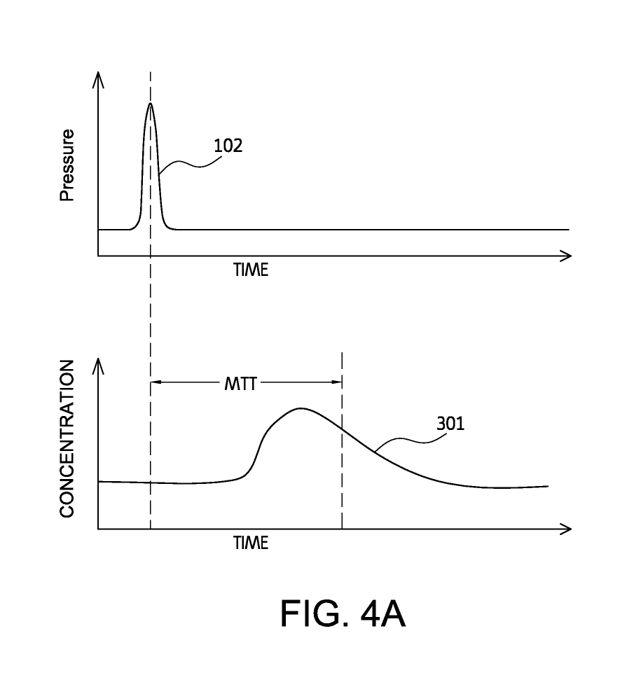

During a volume change, such as a volume injection of an indicator through the indicator introduction port 22, the blood flow rate in the system will change to accommodate the additional volume of the indicator. The change in flow rate in the extracorporeal circuit resulting from the additional volume in the extracorporeal circuit is shown in FIG. 4 as curve 101. Similarly, the volume change will introduce a pressure change in the extracorporeal circuit 10 shown in FIG. 4A as curve 102. Depending on the length and the shape of the injection (indicator introduction), the shape of the flow rate change (or pressure) curve will differ. That is, the shape of the curve representing the volume change such as an injection (the curve representing either as a sensed flow rate change or a sensed pressure change in the extracorporeal circuit 10) will correspond to the parameters (volume and timing) of the introduction of the indicator.

Equation 5 or equivalents may be used to calculate OXBV 68.

OXBV=Q×(MTT_{outflow}−MTT_{flow})−V_{before}−V_{after} [Equation 5]

where MTT_{flow}—is the mean transit time of the introduction of the indicator, such as an injection from curve 101 in FIG. 4 or the pressure curve 102 in FIG. 4A; MTT_{outflow} is the mean transit time from curve 301; V_{after}—is the volume 13 of the extracorporeal circuit 10 between the outlet 64 of the blood treatment device 60 and the outflow sensor 40, (shown as 13 in FIG. 1) and V_{before}—is the volume of the extracorporeal circuit 10 between the indicator introduction port 22 and the inlet 62 to the treatment device 60 (in the case of the injection not immediately upstream of the treatment device).

Thus, the sensed change in the flow rate or pressure change corresponding to the introduced volume of indicator can be used as a first or start time (start of a travel time period of the indicator) and the sensed passage of the introduced indicator at the outflow sensor 40 is a second time (end of the travel period of the indicator). The interval between the first time and the second time represents the travel time of the indicator from the indicator introduction port 22 to the outflow sensor 40.

Thus, a time parameter can be determined from the dilution curve, as a time derived from passage of an indicator through a given portion of the extracorporeal circuit 10. In one embodiment, the time parameter is derived from a sensed dilution curve. The time parameter represents a time corresponding to travel of the indicator through a predetermined portion of the extracorporeal circuit 10. The time parameter can be derived or taken from any portion of the dilution curve. In one configuration, the time parameter is a mean transit time as known in the art.

As seen from Equation 5, when this travel time is multiplied by the sensed (or measured) flow rate in the extracorporeal circuit 10 (and adjusted as necessary for (i) the volume between the indicator introduction port 22 and the inlet 62 of the blood treatment device 60 and (ii) the volume between the outlet 64 of the blood treatment device and the outflow sensor 40).

Any equation that is mathematically equivalent to Equation 5 can be used. It is understood Equation 5 can be simplified by ignoring the contributions of volumes V_{after} and V_{before}. However, ignoring these factors can lead to less accurate results.

Different ways to assess the mean transit times can be employed. Thus, values that are related or proportional to the curves or portions of the measured or sensed curves, such dilution curves can be used. Predetermined curve characteristics can be used as surrogates for the traditional transit time. This flexibility is particularly important when using the present system for dynamic monitoring where an absolute value of OXBV 68 is not critical, but rather changes in OXBV are critical.

Similarly, as long as the change in the flow rate or pressure can be sensed, the indicator can be introduced fast as a very short bolus, as a gradual slow introduction or as step change.

Referring to FIG. 3, a system is provided for introduction of the volume of indicator directly into the blood treatment device 60. The indicator can be injected directly into oxygenator 66. However, in this configuration there is no place to put an inflow sensor 26 for recording of MTT_{inflow}. In this configuration, the injected volume of indicator will produce an increase in flow rate downstream and a decrease in flow rate upstream (depending on the flow resistance of the extracorporeal circuit 10) of the treatment device 60. Correspondingly, the injected volume of indicator will produce an associated pressure change in the extracorporeal circuit 10. The change in flow rate or pressure may be used to assess MTT using the outflow sensor 40, a sensor located upstream of the treatment device or a pressure sensor in the extracorporeal circuit, such as sensor 50 in FIG. 1. In the configuration, wherein the outflow sensor 40 is an ultrasound dilution the outflow sensor can sense (record) both the change in flow rate and then the passage of the dilution curve.

However, a separate dilution sensor and a separate flow sensor can also be used. With the separate sensors, the outflow sensor 40 is the sensor for sensing passage of the indicator, such as a dilution sensor. The flow rate sensor 70 can be located upstream from the location of the indicator introduction, the indicator introduction port 22. In this configuration, the upstream flow rate sensor will sense (record) a decrease of flow during injection, seen as curve 201 in FIG. 4, that can also can be used to calculate OXBV 68 in accordance with Equation 5. Similarly, the pressure sensor 50, connected to controller 90, can be used to determine the introduction of the indicator in the extracorporeal circuit 10.

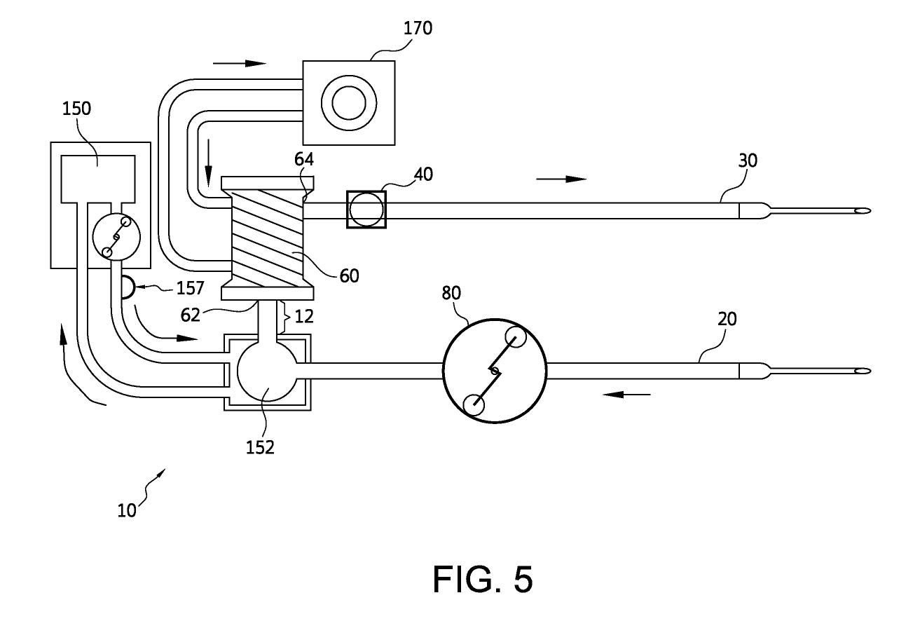

In contrast to the first embodiment in which the indicator is introduced into the blood side, in a second embodiment, the indicator is introduced from the heating/cooling side before oxygenator as seen in FIG. 5. That is, the indicator is coupled to the blood side.

While the first embodiment having the introduction of the indicator in the blood side provides for the flexibility of the system as set forth above, such introduction of the indicator in the blood side can increase the potential of infection. Thus, the second embodiment contemplates introducing the indicator from the heating/cooling side, upstream of the treatment device.

In this configuration, the extracorporeal circuit 10 includes a heating/cooling system (HCS) 150 in addition to the blood treatment device 60, such as the blood oxygenator 66. The HCS 150 cooperates with a heat exchanger, HTEX 152 to heat blood to normal body temperature prior to delivery back to the patient, or to cool blood down, if necessary, such as for inducing hypothermia or reducing body temperature. The heat exchanger 152 includes a larger surface area on the blood side and the HCS side for promoting thermal transfer. The relative flows through the heat exchanger 150 can be concurrent or counter current as known in the art. Typically, the HTEX 152 is located upstream from the blood treatment device 60 and hence upstream of the OXBV 68. However, it is understood some oxygenators include heat exchange surfaces within oxygenator. The current approach to determining OXBV 68 is also applicable to such oxygenators.

In the heating/cooling system (HCS) 150, the heating/cooling of blood is typically provided by a liquid, usually water, that is circulated in the HCS and an external side of the HTEX 152. The heating/cooling system (HCS) 150 includes a bath to impart the necessary temperature to the circulating water. The temperature modified water is then delivered through tubing to the large surface area of the HTEX 152, where the blood of the extracorporeal circuit 10 is flowing on the other side.

As the blood in the extracorporeal circuit 10 and the circulating water of the HCS 150 are only thermally coupled, but do not contact, the second embodiment allows for isolation of the blood in the extracorporeal circuit.

The HCS 150 and HTEX 152 provide the opportunity to deliver heat or cold changes into the blood by changing temperature of the water in the HCS so as to create corresponding changes in the blood of the extracorporeal circuit 10 sufficient to support thermodilution measurements in the extracorporeal circuit.

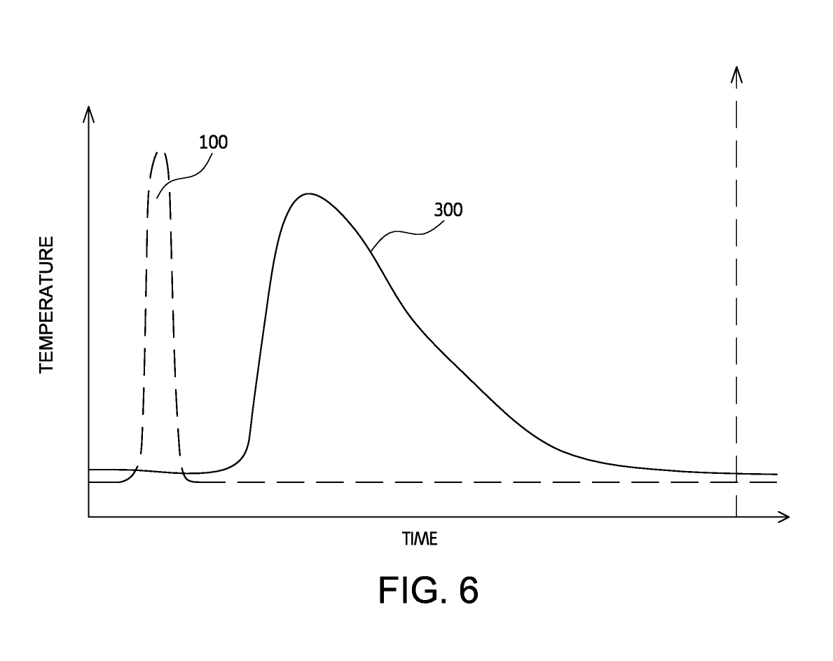

In this embodiment, the temperature of water in the HCS 150 can be changed by a variety of different ways. For example (but not limited to), the water temperature can be changed by an injection (bolus) of warm/cold water at location 157, seen as curve 100 in FIG. 6. Alternatively, the temperature change of the water in the HCS 150 can be imparted by a heating element of the HCS or applying an ice bath or by turning the heating element on and off. The shape of introduced indicator, the temperature changed “bolus” may, (but not limited) be a fast increase (curve 100 in FIG. 6)—a curve corresponding to an injection of cold/warm water in the HCS 150, a step change or a slow [gradual] increase and/or decrease of temperature or even continuous changes, such as a decrease or increase followed by an increase or decrease, such as in sinusoidal temperature changes.

The water temperature bolus in the HCS 150 will transfer through the HTEX 152 into the temperate bolus of the blood in the extracorporeal circuit 10 entering OXBV 68. This introduced blood temperature bolus will travel through the OXBV 68 and produce thermodilution curve (300 in FIG. 6) at the outflow sensor 40. The OXBV 68 can be calculated by transit time of this bolus and a measure blood flow (rate) through the OXBV.

OXBV=Qλ(MTT_{outflow}−MTT_{hcs})−V_{ohc}−V_{after} [Equation 6]

where Q is the blood flow (rate) through the OXBV 68 (which can be measured by a separate flow sensor or by the outflow sensor 40); MTT_{outflow} is the mean transit time that the indicator travels from the location of injection (introduction) to the location of outflow sensor; MTT_{hcs} is the mean transit time that the indicator travels from the location of injection (introduction) in the HCS 150 through the HTEX 152 to the blood location upstream of the OXBV; V_{ohc} is the blood volume 12 between the HTEX and the inlet 62 of the OXBV and V_{after}—is the volume 13 of the extracorporeal circuit between the outlet 64 of the OXBV and the outflow sensor.

Other formulas or the equivalents of this formula can be used to assess OXBV 68 or its equivalents, such as oxygenators where heat exchange is provided within the oxygenator, such as by a heat exchanger in the oxygenator. That is, the correspondence of OXBV 68 to (i) flow rate through the OXBV and (ii) a travel or transit time of an indicator through the OXBV (wherein the travel or transit time can be derived from a dilution curve or sensed change in flow rate), can be expressed with or without accommodation of the blood volume between the HTEX 152 and the inlet 62 of OXBV and the volume of the extracorporeal circuit 10 between the outlet 64 of the blood treatment device 60 and the outflow sensor 40.

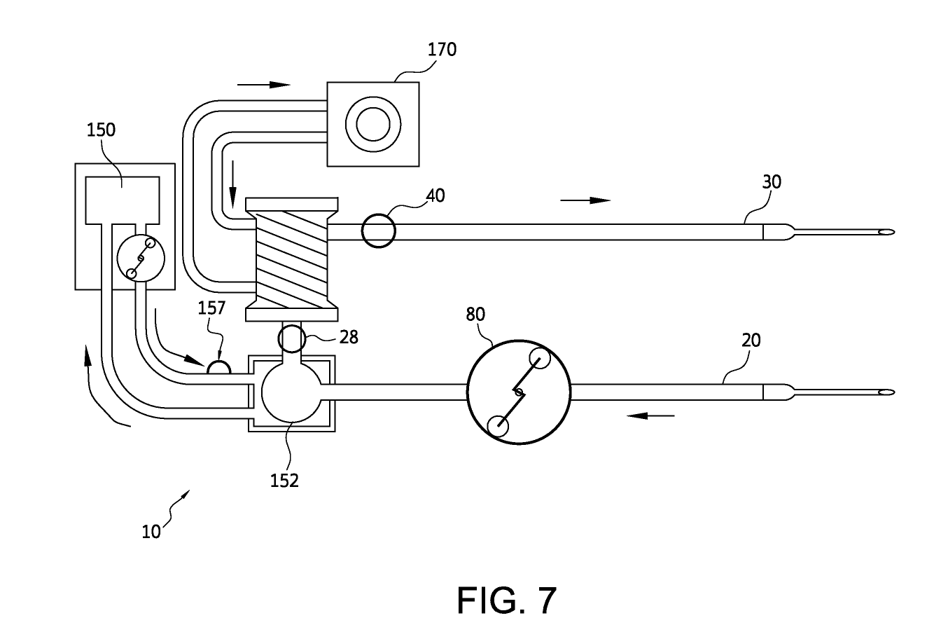

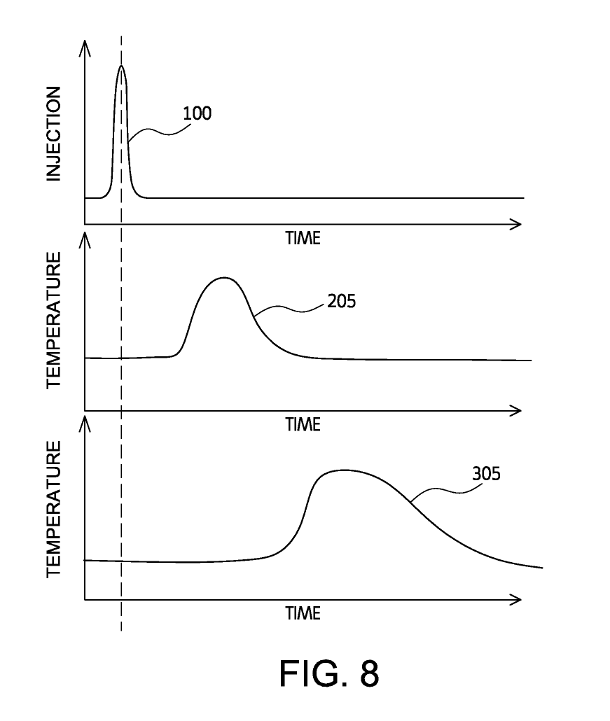

The shape of the introduced heat bolus into the HCS 150, such as the circulating water, can be recorded by a flow sensor in the HCS (if volume injection) and/or by a thermal (dilution) sensor in the HCS. Alternatively or additionally, the shape of the introduced heat bolus into the HCS 150 can be determined in the blood side by a thermal sensor 28 shown in FIG. 7 operably coupled to the extracorporeal circuit 10 upstream of the blood treatment device 60—thus located before blood enters the oxygenator 66, producing dilution curve 205 in FIG. 8. After the indicator passes through the blood treatment device 60, such as oxygenator 66, the thermodilution curve 305 will be recorded by the outflow thermodilution sensor 40 and the OXBV 68 can be calculated analogously to Equation 4.

The temperature bolus can be introduced periodically in the circulating loop of the HCS 150. For example, the temperature bolus can be introduced automatically through a chosen or predetermined period of time to monitor OXBV 68 changes. The time of bolus introduction can be known in the device used for calculation of OXBV 68.

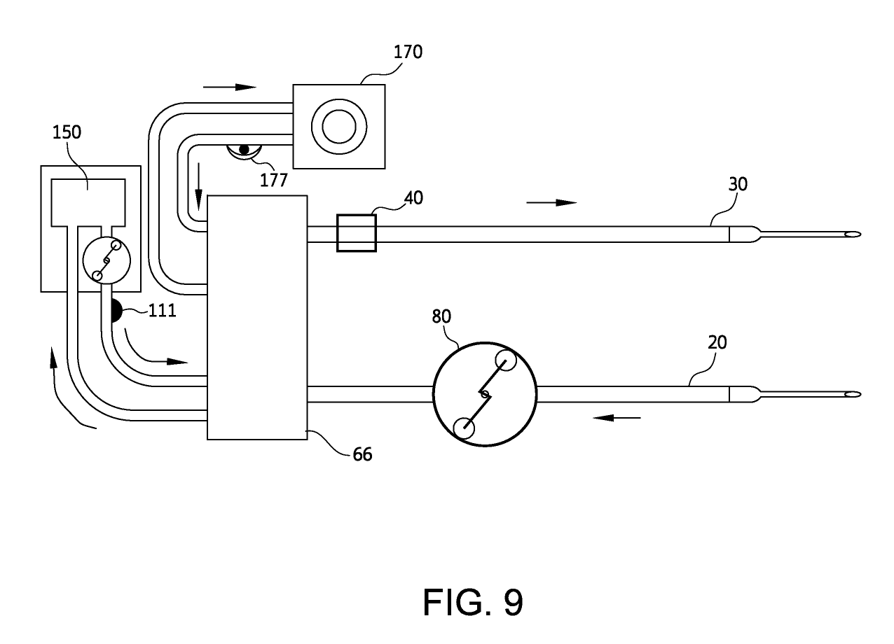

A third embodiment of the system, shown in FIG. 9, introduces indicator (FIG. 9, 111) into oxygenator 66 via HCS 150 or a Gas Delivery System (GDS) 170 through the surface area of the treatment device, such as the oxygenator 66.

In select heating/cooling systems, the temperature is transferred into blood through a large surface area within the oxygenator 66—which is analogous to gas exchanges through a large surface area in the GDS 170.

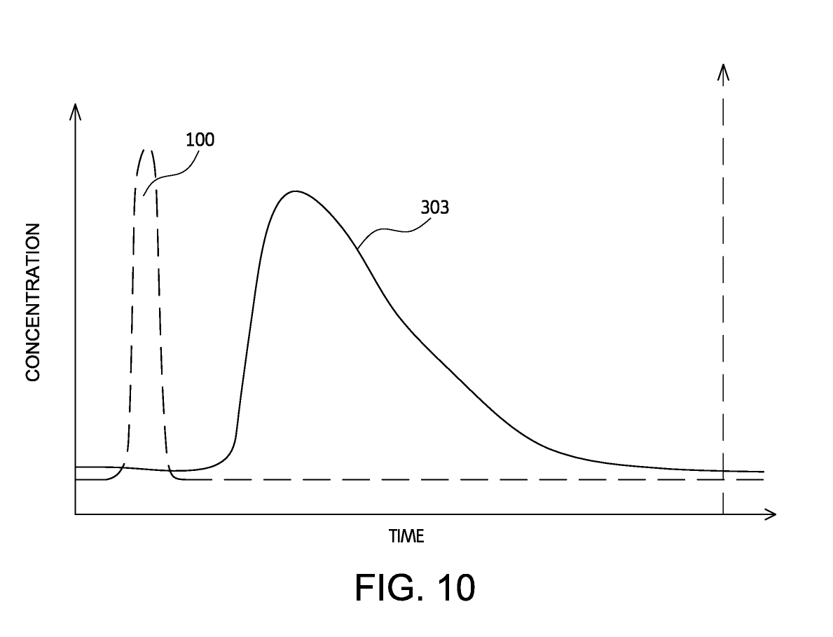

In the GDS 170, the objective is to deliver gas including (not limited) oxygen of a known concentration for treatment of the patient, such as at port 177. An increase or decrease (FIG. 10, curve 100) of gas concentration or gas temperature can produce respective changes in the blood in the extracorporeal circuit 10 upon the blood passing through the oxygenator 66. These changes can be recorded in the blood (FIG. 10, curve 303) by the outflow sensor 40, and the OXBV 68 can be measured.

The heating or cooling process in the HCS 150 also can be used to transfer the thermal indicator into blood, by changes in water temperature (FIG. 10, curve 100) and by recording the temperature changes 303.

In the case where the indicator is directly introduced into the oxygenator 66 (the blood treatment device 60) rather than the blood upstream of the treatment device, the imparted heating/cooling occurs within the oxygenator or the indicator is delivered through the gas delivery system 170, then the OXBV 68 can be calculated (FIG. 10):

OXBV=Q×(MTT_{outflow}−MTT_{g*})−V_{after} [Equation 7]

where Q is the blood flow (rate) through the OXBV 68; MTT_{outflow} is the mean transit time that the indicator travels from the location of injection (introduction) to the outflow sensor 40; MTT_{g*} is the mean transit time that the indicator travels from the location of injection (introduction) through the heating/cooling system or the gas delivery system to blood in the extracorporeal circuit 10, V_{after} is the blood volume between the outlet 64 of the oxygenator 66 and the outflow sensor 40, in this configuration, a dilution sensor.

Mathematical adjustment of Equation 7 can be made to accommodate the indicator entering or being introduced to the blood in the extracorporeal circuit 10 not exactly at the inlet 62, but through the entire surface of the oxygenator 66, to increase accuracy of calculation. For example, a multiplier between 1.001 and 2 could be applied to the factor (MTT_{outflow}−MTT_{g*}) to accommodate the indicator being effectively introduced near the middle of the volume of the blood treatment device 60.

The present system can provide essentially real time dynamic monitoring of the OXBV 68. That is, changes in OXBV 68 can be readily determined either on temporally spaced spot inspections or predetermined period measurements, which could require operator intervention only when a certain threshold of change is determined.

In one configuration, the dynamic monitoring can be employed at the beginning of the procedure (for example ECMO), the OXBV 68 does not have clots, the measurement determined by the present disclosure provides a baseline value proportional or related to initial of OXBV. After operation of the ECMO for a given period of time, the present system can be used to obtain a second value that is proportional or related to initial of OXBV 68. Thus, a change can be determined rather than an absolute value, wherein the changes can be proportional to the initial value, thus avoiding measurements of absolute value of OXBV 68. Thus, the dynamic monitoring can be done any time in the procedure of ECMO or analogous procedures.

Although described in terms of the extracorporeal circuit 10 being physically located outside the body, it is understood, the extracorporeal treatment system also may be located inside the patient body, where patient blood vessels are connected to an artificial structure for blood treatment.

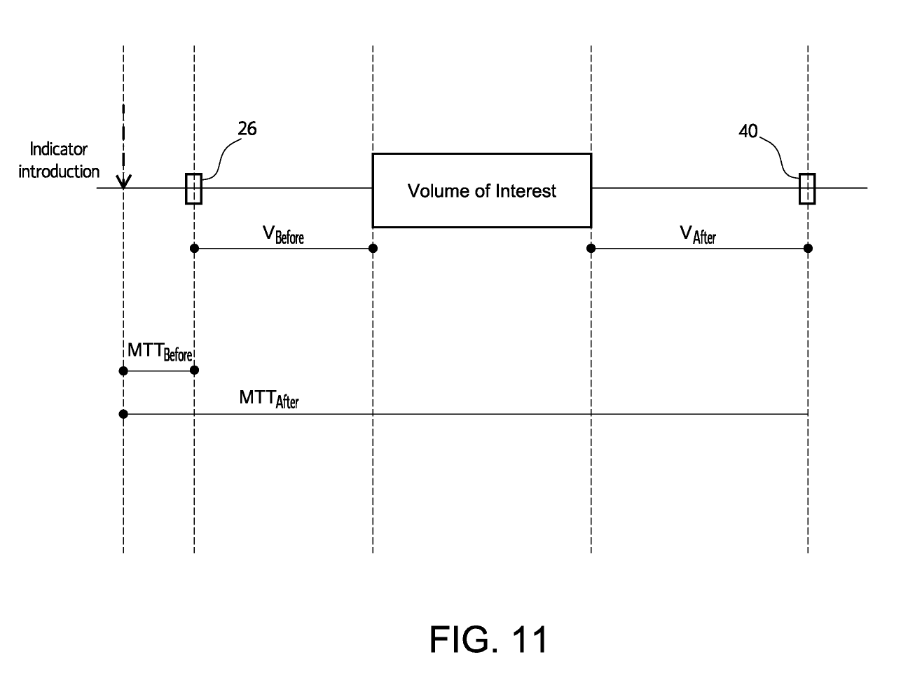

Thus, as seen in FIG. 11, the present system can be used to monitor a volume of interest (VOI) in the extracorporeal circuit, wherein the VOI can include a length of tubing, a pump, a device or any other portion along which blood is to flow. The VOI has an inlet and an outlet. Equation 5, or its equivalents, can be used to calculate a VOI, by:

VOI=Q×(MTT_{outflow}−MTT_{inflow})−V_{before}−V_{after}

where MTT_{inflow}—is the mean transit time that the indicator travels from the location of injection (introduction), such as the indicator introduction port 22, to the inflow sensor 26, or such as derived from an injection from curve 101 in FIG. 4; MTT_{outflow} is the mean transit time that the indicator travels from the location of injection (introduction), such as the indicator introduction port 22 to the outflow sensor 40 or as derived from curve 301; V_{after}—is the volume of the extracorporeal circuit 10 between the outlet of the VOI and the outflow sensor 40, and V_{before}—is the volume of the extracorporeal circuit 10 between the indicator introduction port 22 and the inlet to the VOI (in the case of the injection not immediately upstream of the treatment device).

Depending on the specific configuration of the system, certain terms can be removed from consideration. For example, if the indicator is introduced at or proximate to the inlet of the VOI, then V_{before} does not need to be calculated or known and is taken as zero. Similarly, if the indicator is introduced into the extracorporeal circuit at or proximate to the inlet of the VOI, then MTT_{inflow} does not need to be calculated or known and is taken as zero. In this configuration, if the introduction of the indicator is not sensed with an inflow sensor at the introduction site (at or proximate to the inlet of the VOI), the introduction can be sensed by a change in the flow rate in the extracorporeal circuit 10 as set forth above.

Alternatively, if the outflow sensor is at or proximate to the outlet of the VOI, then V_{after} does not need to be calculated or known.

The dynamic monitoring can thus be applied to any Volume of Interest in the extracorporeal circuit 10.

Although the present invention has been described in terms of preferred embodiments, it will be understood that variations and modifications may be made without departing from the true spirit and scope thereof.

What is claimed is:

1. A method of monitoring a blood volume of an oxygenator in an extracorporeal circuit, the method comprising:
(a) determining a flow rate in the extracorporeal circuit;
(b) injecting an indicator into the extracorporeal circuit;
(c) sensing at least one of a flow rate change and a pressure change in the extracorporeal circuit resulting from the injection of the indicator in the extracorporeal circuit;
(d) determining a time parameter at least partly derived from a dilution curve corresponding to the injected indicator; and
(e) determining the blood volume of the oxygenator based on the determined time parameter and the determined flow rate in the extracorporeal circuit.

2. The method of claim 1, wherein the time parameter is determined from the dilution curve and the at least one of the sensed flow rate change and the sensed pressure change.

3. The method of claim 1, wherein the time parameter is determined from passage of a predetermined portion of the dilution curve and the at last one of the sensed flow rate change and the sensed pressure change.

4. The method of claim 1, further comprising adjusting the determined blood volume by a volume of the extracorporeal circuit upstream of the oxygenator.

5. The method of claim 1, wherein an occurrence time of the injected indicator is determined from the sensed one of the flow rate change and the pressure change in the extracorporeal circuit.

6. The method of claim 1, wherein the blood volume of the oxygenator OXBV is determined by Q×(MTT_{outflow}−MTT_{flow})−V_{before}—V_{after}, where MTT_{flow}—is the mean transit time of the introduction of the indicator; MTT_{outflow} is the time parameter in the form of a mean transit time derived from the dilution curve; V_{after}—is the volume of the extracorporeal circuit between an outlet of the treatment device and the outflow sensor and V_{before}—is the volume of the extracorporeal circuit between the indicator introduction port and an inlet to the oxygenator.

7. A method of monitoring a blood volume of an oxygenator in an extracorporeal circuit, the method comprising:
(a) introducing, at an introduction location, a temperature change to passing blood in the extracorporeal circuit, the temperature change corresponding to a temperature in a heating/cooling system thermally coupled to the extracorporeal circuit;
(b) sensing passage of the introduced temperature change in the extracorporeal circuit downstream of the oxygenator;
(c) determining a time parameter derived from travel of the introduced temperature change from the introducing location to the sensor; and
(d) determining the blood volume of the oxygenator based on a blood flow rate in the extracorporeal circuit and the time parameter.

8. The method of claim 7, further comprising sensing, with a sensor located upstream of the oxygenator, passage of the introduced temperature change in the passing blood.

9. The method of claim 7, wherein introducing a temperature change to passing blood in the extracorporeal circuit includes one of (i) introducing the temperature change through a heating/cooling system thermally coupled to the extracorporeal circuit at an introducing location in the extracorporeal circuit and (ii) introducing a volume of indicator into the extracorporeal circuit, the volume of indicator having a different temperature than the passing blood.

10. The method of claim 7, wherein introducing a temperature change to passing blood in the extracorporeal circuit includes introducing a volume of indicator into the extracorporeal circuit, upstream of the oxygenator.

11. The method of claim 7, wherein introducing a temperature change to passing blood in the extracorporeal circuit includes introducing a volume of indicator into a temperature control circuit thermally coupled [fluidly separated] to the extracorporeal circuit, upstream of the oxygenator.

12. The method of claim 7, further comprising adjusting the determined blood flow by a volume of the extracorporeal circuit between an outlet of the oxygenator and the sensor located in the extracorporeal circuit downstream of the oxygenator.

13. The method of claim 7, wherein the determined blood volume OXBV corresponds to Q×(MTT_{outflow}−MTT_{hcs})−V_{ohc}−V_{after}, where Q is the blood flow through the oxygenator; MTT_{outflow} is the time parameter mean transit time of the indicator from a location of indicator introduction to the outflow sensor; MTT_{hcs} is the time parameter mean transit time of the indicator from the location of indicator introduction in the HCS through the HTEX to the blood location upstream of the oxygenator; and V_{ohc} is the blood volume between the HTEX and the inlet of OXBV and V_{after}—is the volume of the extracorporeal circuit between an outlet of the oxygenator and the outflow sensor,

14. A method of monitoring a blood volume of an oxygenator in an extracorporeal circuit, the method comprising:
(a) introducing, from gas delivery system coupled to the extracorporeal circuit, a change in a gas property of blood flowing in the extracorporeal circuit;
(b) sensing in the extracorporeal circuit downstream of the oxygenator passage of the changed gas property in the blood; and
(c) calculating the blood volume of the oxygenator based on a blood flow rate in the extracorporeal circuit and a time parameter derived from travel of the changed gas property from the introduction to the sensor.

15. The method of claim 14, wherein calculating the blood volume is further based on a volume of the extracorporeal circuit between the oxygenator and the sensor located downstream of the oxygenator.

16. The method of claim 14, wherein the gas property is one of concentration of a gas in the blood or a temperature of the blood.

17. A method of dynamically monitoring an oxygenator blood volume in an extracorporeal circuit, the method comprising:
(a) determining at a first time, a first relative oxygenator blood volume corresponding to a first flow rate in the extracorporeal circuit and a first time parameter derived from a sensed passage by an outflow sensor of a first indicator through the oxygenator;
(b) determining at a second time, a second relative oxygenator blood volume corresponding to a second flow rate in the extracorporeal circuit and a second time parameter derived from a sensed passage by the outflow sensor of a second indicator through oxygenator; and
(c) comparing the first relative oxygenator blood volume and the second relative oxygenator blood volume to assess a change in oxygenator blood volume.

18. A method of monitoring a blood volume of an oxygenator in an extracorporeal circuit, the method comprising:
(a) determining a flow rate in the extracorporeal circuit;
(b) injecting an indicator into the extracorporeal circuit;
(c) sensing a time of occurrence of the injection of the indicator in the extracorporeal circuit;
(d) determining a time parameter at least partly derived from a dilution curve corresponding to the injected indicator; and
(e) determining the blood volume of the oxygenator based on the determined time parameter and the determined flow rate in the extracorporeal circuit.

19. The method of claim 18, wherein the time parameter is determined from the dilution curve and the at least one of the sensed flow rate change and the sensed pressure change.

20. The method of claim 18, wherein the time parameter is determined from passage of a predetermined portion of the dilution curve and the at last one of the sensed flow rate change and the sensed pressure change.
